(19) United States
(12) Patent Application Publication
(10) Pub. No.: US 2005/0215672 A1
(43) Pub. Date: Sep. 29, 2005

(54) Anhydride functionalized polyhydroxyalkanoates, preparation and use thereof

(75) Inventors: Amar K. Mohanty, Lansing, MI (US); Lawrence T. Drzal, Okemos, MI (US); Shrojal M. Desai, Seattle, WA (US); Manjusri Misra, Lansing, MI (US); Prasad Mulukutla, St. Paul, MN (US)

Correspondence Address: Ian C. McLeod;McLeod & Moyne, P.C., 2190 Commons Parkway, Okemos, MI, 48864, US

(73) Assignee: Board of Trustees of Michigan State University, East Lansing, MI (US)

(21) Appl. No.: 11/056,622

(22) Filed: Feb. 11, 2005

Related U.S. Application Data
(60) Provisional application No. 60/543,825, filed on Feb. 11, 2004.

(51) Int. Cl. C08K 11/00

(52) U.S. Cl. 524/9

(57) ABSTRACT

A process and composition using anhydride grafted polyhydroxyalkanoate (PHA) polymer (grafted polymer) which has been extruded with a PHA polymer (non-grafted) and a dried cellulose fiber which reacts with the maleated PHA is described. The composites formed have improved mechanical properties.

### CROSS-REFERENCE TO RELATED APPLICATIONS

This application claims priority to Provisional patent Application Ser. No. 60/543,825, filed Feb. 11, 2004.

### STATEMENT REGARDING GOVERNMENT RIGHTS

The invention was funded under a National Science Foundation Grant (NSF-PREMISE 0225925) and under an Environmental Protection Agency Grant (EPA STAR Award No. RD-83090401. The U.S. Government has certain rights in this invention.

### BACKGROUND OF THE INVENTION

1. Field of the Invention

The present invention also relates to the process for the fabrication of biocomposites of polyhydroxyalkanoates (PHAs) with fibers with the use of anhydride grafted PHAs (PHAs bearing anhydride groups) as compatibilizers. The fibers react with the grafted PHAs.

2. Description of Related Art

Polymers are one of the most significant inventions of the past century. One of the most widely used polymers is polyolefins derived from petroleum. Their versatility and cost-effectiveness is one of the main reasons for their rapid adaptability as commodity materials, almost replacing metals and glass in many applications. However, extensive use of these polymers has raised several environmental concerns due to their non-biodegradability and adverse effect on nature. Moreover, synthetic polyolefins are derived from petroleum, which is a non-renewable finite resource. In the wake of these shortcomings of petroleum-based polymers, a desperate need for an alternate material has been experienced for more than past three decades. The desire for ‘green’ products is driving research towards the development of renewable resource-based sustainable biocompatible materials.

Polyhydroxyalkanoates (PHAs) are biodegradable and biocompatible thermoplastic polyesters with properties similar to those of classical polyolefins. PHAs have attracted much attention as environmentally degradable resins, which are useful for a wide range of applications. However, PHAs are highly hydrophobic and degrade thermally during processing. More particularly, polyhydroxybutyrate (PHB) one of the members of PHA family is a crystalline polymer and its main drawbacks are its brittleness, narrow processing window and thermal instability. These shortcomings can be overcome both by plasticizing the polymer and by copolymerizing PHA with suitable functional polymers/oligomers. Graft copolymerization is a well-known and established route to modify the chemical and physical properties of polymers. Free radical grafting of maleic anhydride onto polyolefins is carried out to improve the fiber—matrix compatibility in the composites.

The reaction of maleic anhydride with various polymers is available in the literature (Chung and Lu, J. Polym. Sci. Polym Chem. A; 38, 1337 (2000); and Gaylord, N. G., U.S. Pat. No. 4,506,056). The grafting of maleic anhydride onto saturated polymers (especially polyolefins) in the presence of free radicals, either generated by shearing or by heating free radical precursors such as organic peroxides, is also know in the art (Aglietto et al., U.S. Pat. No. 6,451,919 B1). However, modification of polyhydroxyalkanoates (PHA) via grafting is rarely reported. Yoshi et al. (Radiat Phys Chem, 46, 233 (1995)) reported radiation graft behavior of methyl methacrylate (MMA), 2-hydroxyethyl methacrylate (HEMA), acrylic acid (AAc) and styrene onto PHB and its copolymers. Lee et al. (Polymer 38, 4505 (1999)) studied graft copolymerization of acrylamide onto poly(hydroxybutyrate-co-hydroxyvalerate) films for its permselectivity. However, these reports are about surface graft copolymerization in the presence of a solvent, restricted to the surface modification of PHA films.

(2) Description of Related Art

U.S. Patent Application No. 2002/0128382 A1 to Wang et al, published Sep. 12, 2002 generally describes PHA grafted maleic anhydride polymers with no examples. Related applications are U.S. 2002/0128384 A1 and U.S. 2003/0018128 A1 Jan. 28, 2003 to Wang et al.

Other related art is:
Chung and Lu, J. Polym. Sci., Polym Chem. A; 38,1337 (2000);
N. G. Gaylord, U.S. Pat. No. 4,506,056, Maleic anhydride modified polymers and process for preparation thereof;
Aglietto et al., U.S. Pat. No. 6,451,919 B1, Polyolefins functionalized with maleic anhydride and with its high boiling liquid esters, and their use as products with high compatibilizing power;
Yoshi et al., Radiat Phys Chem, 46, 233 (1195);
H. S. Lee and T. Y. Lee, Polymer, 38, 4505 (1999);
R. Mani, M. Bhattacharya, J. Tang, J. Polym. Sci. A: Polym. Chem., 37, 1693 (1999); and
Mitomo, H., et al., Radiat. Phys. Chem. Vol. 46, No. 2, pp. 233-238 (1995).

### OBJECTS

One of the objects of the present invention is to provide a process for the preparation of composites using polyhydroxyalkanoates bearing pendant anhydride groups in varying amounts along with natural fibers. In particular, it is an object to reduce the crystallinity of polyhydroxybutyrate (PHB), improve its processing window, enhance its adhesive strength with natural fibers, and to use it as compatibilizer in the preparation of biofiber/natural fillers composites of PHAs. Another object of the present invention is to prepare sustainable biofiber composites from PHAs and natural fibers/natural fillers, with maleated PHAs as compatibilizers. These and other objects will become apparent from the following description and the drawings.

### SUMMARY OF INVENTION

The invention provides a process for the preparation of modified PHA polymers containing pendant anhydride groups in varying proportions for use as a compatibilizer in the preparation of natural fiber composites with various PHAs.

### SUMMARY OF INVENTION

The present invention provides a composite composition prepared by a method which comprises premixing of a PHA polymer with a PHA grafted with pendant anhydride groups as a compatibilizer, a dried fiber which reacts with the compatibilizer in an external blender at room temperature with purging in a mechanical mixing device with an internal temperature set above the melting point of the polymer and below the degradation temperature of any of the components of the composite, having single or multiple ports and manual or automatic purging facility, and the fiber is added through one of these ports.

Preferably the fiber is bast or leaf fiber or any other cellulosic filler or fiber. Preferably the fiber is hemp, kenaf, sisal or flax. Preferably the fiber is henequen or pineapple leaf fiber. Preferably the fiber is a native grass fiber. Preferably the fiber is a synthetic cellulose fiber. Preferably the fiber is wood flour. Preferably the fiber is varied between about 5 to 50 wt. %. Preferably the composite is in the form of pellets, strands or power. Preferably the composite material is molded into various shapes by placing the composite in a suitable mold at a working temperature and pressure for the molding. Preferably the concentration of the compatibilizer is between 1 to 12 weight percent (wt %).

The present invention provides a composite wherein the polyhydroxyalkanoate (PHA) grafted with the pendant anhydride of the formula I: 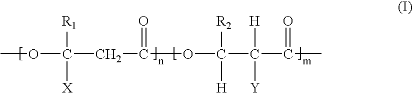
wherein X and Y are each individually selected from the group consisting of an alkyl, cycloalkyl, aryl group containing 1 to 20 carbon atoms linked to an anhydride moiety, wherein if R₁ is equal to R₂ as a homopolymer then n is equal to m and are between about 100 to 1000, and wherein R₁ is not equal to R₂ as a co-polymer, then n and m are from about 100 to 800, but not restricted to these numbers.

The present invention provides the composite wherein the polyhydroxyalkanoate grafted with the pendant anhydride of claim 1 having the general formula (I) 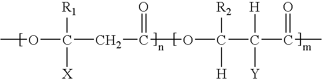
wherein R₁ is methyl, ethyl, C₁ to C₁₂ alkyl (linear and branched), R₂ is C₁ to C₁₂ alkyl (linear and branched) and X is grafted anhydride selected from the group consisting of maleic anhydride, octadecenyl succinic anhydride, nadic anhydride, and ring substituted derivatives thereof, Y is hydrogen, is grafted anhydride selected from the group consisting of maleic anhydride succinic anhydride, octadecenyl succinic anhydride, nadic anhydride, and ring substituted derivatives thereof, and wherein if R₁ is not equal to R₂ as a copolymer then m and n are from between about 100 to 800, but are not restricted to these numbers.

The present invention provides a polyhydroxyalkanoate (PHA) grafted with pendant anhydride groups.

Further, the present invention provides a polyhydroxyalkanoate (PHA) grafted with an anhydride of the formula: 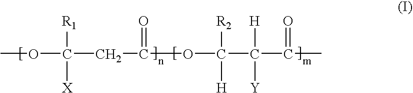
wherein m is between about 100 to 1000, wherein X and Y are each individually selected from the group consisting of an alkyl, cycloalkyl, aryl group containing 1 to 20 carbon atoms linked to an anhydride moiety, wherein if R₁ is equal to R₂ as a homopolymer then n is equal to m and are between about 100 to 1000, and wherein if R₁ is not equal R₂ as a co-polymer, then n and m are from about 100 to 800, but are not restricted to these numbers. Preferably the molecular weight of the homopolymer is from about 8000 g/mol to 80,000 g/m. Preferably for the copolymer (i.e. PHBV) n is between about 400 to 800 and m is between about 100 to 200.

The present invention further provides a polyhydroxyalkanoate having the general formula (I) 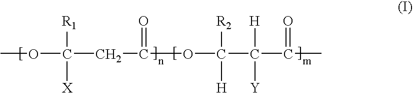
wherein R₁ is methyl, ethyl, C₁ to C₁₂ alkyl (linear and branched), R₂ is C₁ to C₁₂ alkyl (linear and branched) and X is grafted anhydride selected from the group consisting of maleic anhydride, octadecenyl succinic anhydride, nadic anhydride, and ring substituted derivatives thereof, Y is hydrogen, is grafted anhydride selected from the group consisting of maleic anhydride, succinic anhydride, octadecenyl succinic anhydride, nadic anhydride, and ring substituted derivatives thereof and wherein if R₁ equals R₂ as a homopolymer then n equals m and are between about 100 to 1000, and wherein if R₁ is not equal R₂ as a copolymer then m and n are from between about 100 to 800. Preferably in the copolymer n is between about 3000 to 6000 and m is between about 700 to 1400.

Finally the present invention provides a process for the preparation of grafted polyhydroxyalkanoate (PHA) bearing pendant anhydride groups, which comprises of mixing together (1) an anhydride, (2) free radical initiator, and (3) a PHA polymer undergoing deformation in bulk or in melt at a temperature where the PHA is formed. In the present invention, maleation of PHAs is intended to improve their physico-chemical properties, in particular decrease crystallinity and improve adhesion with reinforced fibers in the composites. The adhesion of the natural biofibers/natural fillers with the polymer is enhanced by the interaction of anhydride groups with the hydroxyl groups of cellulose in the fiber.

This eventually improves the physical and mechanical properties of the polymer composite materials like modulus, tensile, flexural and impact strength as compared to the unmodified matrix. These modified bacterial polyesters can act as compatibilizers in the fabrication of composites derived from natural fibers natural fillers. Addition of a small amount of this compatibilizer can improve fiber compatibility with polymer matrix, which in turn increases the mechanical properties of the composite materials as a whole. The aim of the present invention is also to develop a process for preparation of sustainable PHB—natural fiber biocomposites with excellent thermo-mechanical properties.

The process of the present invention will have following unique advantages for modification of PHAs:
1) Highly economical and industrially feasible process;
2) Mild reaction conditions and commonly available reagents;
3) Control of the degree of modification of PHA;
4) Solvent free grafting reaction;
5) Avoids tedious purification;
6) Environmentally benign reaction;
7) Completely biodegradable composites;

Thus, this disclosure provides a process for the preparations of newly modified PHA polymers containing pendant anhydride groups in varying proportions, their use as compatibilizer and process for the preparation of biofiber composites of PHAs, using those.

The present invention thus relates to the PHAs grafted with a pendant anhydride group. In particular the present invention relates to solvent free maleation of PHAs, in particular, polyhydroxybutyrate and polyhydroxyvalerate using a co-rotating twin-screw extruder. Thus, this process would be cost effective and environmentally advantageous for its solvent free approach, increasing the potential of these materials as biobased plastics. Secondly, the composites made from PHAs with natural fibers are biodegradable unlike the composites made with petroleum based plastics and glass fibers as known from the prior art. Moreover, glass fibers have a high density, are energy intensive to produce and are difficult to recycle.

The present invention relates to a process for the preparation of a composite of a grafted polyhydroxyalkanoate (PHA) compatibilizer bearing the pendant anhydride groups, which comprises mixing together (1) an hydride, (2) free radical initiator and (3) a PHA polymer at a temperature where the PHA melts; and mixing the compatibilizer with PHA and a dried biodegradable fiber which reacts with the compatibilizer.

Preferably the PHA is a homopolymer or a copolymer. Preferably the free radical initiator is selected from the group consisting of organic peroxy compounds and azo compounds. Preferably the organic peroxy compound is selected from the group consisting of peroxides, hydroperoxides, peroxy esters and ketone peroxides. Preferably the PHA is poly(3-hydroxybutyrate) as a homopolymer. Preferably the PHA is poly(3-hydroxy valarate) as a homopolymer. Preferably the PHA is poly(3-hydroxypropionate) as a homopolymer. Preferably the PHA is poly(3-hydroxycaproate) as a homopolymer. Preferably the PHA is poly(3-hydroxyoctanoate) as a homopolymer. Preferably the PHA is poly(3-hydroxydecanoate) as a homopolymer. Preferably the PHA is poly(3-hydroxyundecanoate) as a homopolymer. Preferably the PHA is poly(3-hydroxycodecanoate) as a homopolymer. Preferably the PHA is poly (3-hydroxybutyrate-co-3-hydroxy valerate) as a copolymer. Preferably the anhydride bears an unsaturation in its cyclic structure or has a mono unsaturation in its aliphatic side chain. Preferably the anhydride is maleic anhydride. Preferably the anhydride is nadic anhydride. Preferably the anhydride is nadic methyl anhydride. Preferably the anhydride is octadecenyl succinic anhydride. Preferably the anhydride is tetradecenyl succinic anhydride. Preferably the anhydride is hexadecenyl succinic anhydride. Preferably the anhydride is dodecenyl succinic anhydride. Preferably the anhydride is tetrapropenyl succinic anhydride. Preferably the mixing is with a mechanical mixing device which is a single or twin screw extruder. Preferably the mechanical mixing device is an extruder. Preferably the mixing is with a roll mill. Preferably the grafting is carried out in the temperature which is between about 135-190° C. Preferably the screw speed of a mechanical mixing device is varied between about 50-150 rpm. Preferably the residence time of the mixing is between about 1 and 5 minutes. Preferably a free radical initiator is between about 0.4 to 3.0 weight percent (wt %) of the polymer. Preferably the concentration of anhydride is between 1-15 wt % of the polymer. Preferably purification of the grafted PHA can be done either in situ or separately. Preferably an in situ purification of maleated PHA is by applying vacuum to vent off volatile unreacted anhydride. Preferably an external purification is done by heating the PHA under a dynamic or static vacuum for time ranging between about 6-14 hours. Preferably the grafting is in a mixing device under an inert atmosphere to control the thermo-oxidative degradation. Preferably the inert atmosphere is with a non-reactive gas like nitrogen or argon.

### BRIEF DESCRIPTION OF DRAWINGS

FIGS. 1A to 1D are schematic drawings of a laboratory scale extruder.

FIG. 1E is a schematic drawing of a commercial scale extruder with a manual (port 7) and automatic (port 4) feed ports.

FIG. 2A is a ¹H-NMR scan of PHB (P-226).

FIG. 3A is a ¹H-NMR scan of PHB (P-226)-g-MA wherein MA is a maleic anhydride derived moiety. “g” is grafted.

FIG. 3B to 3D are enlarged sections of FIG. 3A.

FIG. 4A is a ¹³C-NMR scan of PHB (P-226)-g-MA.

FIG. 4B is a schematic view of the MA grafting on a PHB segment.

FIGS. 5A and 5B are FTIR spectra of PHB (P-226)-g-MA at different concentrations of MA.

FIG. 6 is a graph of TM measurements for PHB (P-226) and PHB (P-226)-g-MA using DSC. (A) is unplasticized PHB, (B) is PHB (P-226), (C) is Example 3 and (D) is Example 7.

FIGS. 7A and 7B are optical micrographs of ungrafted plasticized PHB (P-226) and PHB (P-226)-g-MA.

FIG. 8A is a ¹³C-NMR spectrum of PHB (P-226)-g-ODSA where ODSA is octadecenyl succinic anhydride.

FIG. 8B is a structured formula of a unit of PHB with the grafted ODSA.

FIG. 9 is a graph of a FTIR spectra of PHB (R-226)-g-ODSA at various initiator concentrations.

FIG. 10 is a graph of DSC thermograms showing Tm of various samples of PHB (P-226) and PHB (P-226)-g-ODSA and various ODSA and initiator LUPROX 101 concentrations.

FIG. 11 is a graph of a FTIR spectra of PHB (P-226) and PHB (P-226)-g-ODSA using ligand LUPROX 101 concentrations.

FIG. 12 are graphs of two (2) DSC thermograms showing the effect of liquid initiator (LUPROX 101) on Tm values of PHB (P-226)-g-ODSA at different ODSA concentrations.

FIGS. 13A and 13B are optical microscopy images of PHB crystals before (13A) and after (13B) modification by grafting of ODSA.

FIG. 14 is a graph of a FTIR spectra of PHBV-g-MA with TRIGONOX 101 45 B (which is 2,5-bis (tert-butylperoxy)-2,5-dimethyl hexane on a solid support) at different MA concentrations.

FIG. 15A is an enlarged view of ¼ inch henequen fiber.

FIG. 15B is an enlarged view of ¼ inch hemp fiber.

FIG. 16 is a schematic view of an extruder for PHB and biofiber composite processing.

FIG. 17A is a photographic view of PHB henequen fiber PHB composite pellets. FIG. 17B is a photographic view of PHB/hemp fiber composite pellets.

FIG. 18A is a photographic view of prior art PHB/henequen fiber composite as a tensile coupon. FIG. 18B shows a standard coupon for a PHB (P-226)/hemp fiber composite. Both 18A and 18B contained PHB (P-226)-g-MA as a compatibilizer.

FIGS. 19A and 19B are schematic views of the screw configuration in the extruder of FIG. 1E. FIG. 19A is for the manual addition mode, and FIG. 19B is for the automatic addition mode.

### DESCRIPTION OF PREFERRED EMBODIMENTS

Functionalized polyhydroxyalkanoates with pendant anhydride groups grafted onto the backbone can be prepared by reacting PHAs with free radical initiations and suitable saturated or unsaturated anhydrides.

More particularly, the present invention provides the said compound of formula (I) prepared using compound having general formula (II): 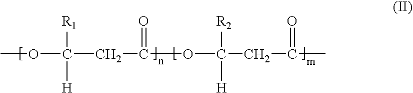
wherein, R₁ is C₁ to C₁₂ alkyl (linear and branched), R₂ is methyl, C₁ to C₁₂ alkyl (linear and branched) by reacting it with an anhydride having general formulas (III) and (IV): 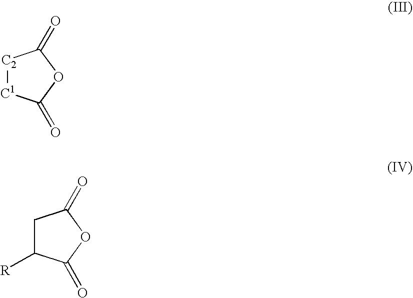
Wherein, C₁ and C₂ are unsaturated or saturated carbon, substituted with H, linear or cyclic alkenes and R is linear or branched vinyl or allyl hydrocarbon, C₁-C₂₀ linear or branched monoalkene, reacting in presence of peroxy or azo alkyl free radical initiator having general formulas (V-VIII) where R₁-R₈ are methyl, ethyl, isopropyl, tert-butyl, alkyloxy, aryl, arylalkyl, but not restricted to these molecules.

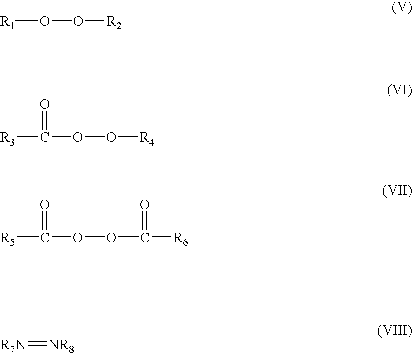

In one of the embodiments of the present invention, the bacterial polyesters are homopolymer and copolymers of hydroxybutyric acid and its alkyl substituted derivates having general formula (II) and can be selected from poly(3-hydroxybutyrate), poly(3-hydroxyvelarate), poly(3-hydroxypropionate), poly(3-hydroxycaproate), poly(3-hydroxyoctanoate), poly(3-hydroxydecanoate), poly(3-hydroxyundecanoate), poly(3-hydroxycodecanoate) and poly(3-hydroxybutyrate-co-3-hydroxyvalerate) but is not limited to these polymers.

The polymer can be plasticized in order to decrease its crystallinity, increase its processing window and thereby prevent its degradation during processing. Plasticizers can be chosen from tri-n-butyl citrate, tri-n-ethyl citrate, diethylhexyl phthalate, but not restricted to these.

In one of the other embodiments of the present invention, the anhydride group insertion in the backbone of compound having formula (II) is achieved by using maleic anhydride, nadic anhydride, vinyl derivatives of succinic anhydride and all anhydrides bearing unsaturated linear or cyclic substitutions and can be selected from; n-Dodecenyl succinic anhydride, n-Octadecenyl Succinic Anhydride, n-Tetradecenyl succinic anhydride. However, it is not restricted to these molecules.

In yet another embodiment, the free radical initiators or catalyst which are useful in the practice of this invention are solids, liquids or those supported on solid support like talc and other clays, having half lives of less than 3 hours at reaction temperature. The free radical initiators can be chosen from acyl peroxides as benzoyl peroxide, dialkyl or arylalkyl peroxides such as di-tert-butyl peroxide, cumyl butyl peroxide, 1,1-di-tert-butyl peroxy-3,5,5-triemthylcyclohexane, 2,5-bis(tert-butyl peroxy)-2,5-dimethylhexane and bis(α-tert-butyl peroxyisopropylbenzene), peroxyesters such as tert-butyl peroxypivalate, tert-butyl peroctoate, tert-butyl perbenzoate, dialkyl peroxymonocarbonates and peroxydicarbonates, hydroperoxides such as tert-butyl hydroperoxide, pinane hydroperoxide and cumene hydroperoxide and ketone peroxide as cyclohexanone and methyethyl ketone peroxide as well as azo compounds such as azobisisobutyronitrile. Any free radical initiator having the desired half-life at the reaction temperature may also be used. Free radical initiators or catalyst selected for carrying out free radical grafting having general formula (V-VIII) is selected from all those mentioned above but are not restricted to those.

In yet another embodiment, the reaction is maintained under inert conditions using common inexpensive inert gases and can be chosen from nitrogen and argon.

In yet another embodiment a mixture of suitable anhydride and free-radical initiator and polymer is homogenously premixed using a blender at room temperature. The mixture containing polymer, initiator, and anhydride is purged into suitable mixing device with its internal temperature set above the melting point of the polymer (and below its degradation temperature) such as single or multiple screw extruder, Brabender PLASTICODER™ extruder (South Hackensack, N.J.), roll mill or any other well-known mechanical mixing equipment normally used for mixing, compounding or processing polymers or mixtures thereof. An extruder having one or more ports is particularly desirable reaction vessel, although it is by no means mandatory.

In yet another embodiment, the solid polymer, e.g. pellets or powder, may be premixed with the suitable anhydride and initiator and the resultant mixture added to mixing device. Alternatively, the mixture of reactants may be added to the molten polymer also.

In yet embodiment, the mixture of anhydride and radical initiator is prepared in conventional manner and may be in the form of a mixture of powdered solids when all of the ingredients have melting points above room temperature, a slurry or a paste when the additive and or the catalyst are liquids at room temperature, or a liquid or fluid when one of the components is soluble in other additive and or catalyst.

In yet another embodiment, the mixture is dropped continually or intermittently onto the polymer undergoing deformation. e.g. in a Brabender PlASTICODER, roll mill or extruder. When the mixture is solid, it may be added mechanically, e.g. from a hopper or may be blown in with an inert gas. When the mixture is a paste, slurry or fluid, it may be added mechanically or may be pumped for sprayed onto the surface of the polymer through the ports in the extruder. Various methods of addition of solids, slurry or liquids to the reaction vessels, mills and extruder are well known to those skilled in the art and may be used in the practice of this invention.

In yet another embodiment, the mixture is generally added continuously or in several portions over period of time to promote homogenous distribution of anhydride groups throughout the mass of the polymer. The grafting reaction is extremely rapid and occurs to a major extent when the mixture comes in contact with the heated molten polymer. However, the reaction can continue when the molten polymer is conveyed away from the point of injection, particularly if the half-life of the imitator or catalyst is at least 10 seconds at the reaction temperature.

In yet another embodiment, extruder containing any entry port for the addition of the polymer, one or more reduced pressure zones with injection orifices at pointes where the polymer is molten for addition of the reactant mixture, and a reduced pressure zone for venting off any unreacted anhydride or volatiles formed during the process, may be used advantageously in the practice of this invention. In this case the extrudate may be removed as ribbon or blown film or as strands and can be cut into pellets.

In yet another embodiment, the temperature of all the zones of mechanical mixing equipment is varied from 190-135° C. in such a way that the polymer-melt temperature remains below its degradation temperature. The screw rotation speed is varied between 50 to 150 rpm and the residence time is maintained between 1-5 minutes. However, the processing parameters can be changed so as to get best grafting yields and desired properties of the extrudate.

In yet another embodiment, the modified polymer may be freed of unreacted anhydride by vacuum drying over a period of 6-14 hours. Alternatively, dissolving the modified polymer in a suitable solvent and precipitation from a non-solvent can also eliminate the unreacted anhydride.

In yet another embodiment, the anhydride content of the grafted PHAs normally varied from 0.2 to 4.0 wt % and further more as desired.

In yet another embodiment, the concentration of the free radical initiator is generally between 0.4 and 3.0 wt % of polymer.

In yet another embodiment, the process of anhydride content determination in the grafted PHA involves its treatment with methanolic KOH in refluxing chloroform and back titration with isopropanolic HCl.

This invention is aimed at PHB—natural fiber biocomposites preparation and improving their properties using maleated PHB as compatibilizer. The enhancement in the mechanical properties of these composites is also described. Grafting of anhydride groups onto the PHB by this reactive extrusion process introduces reactive functional groups onto PHB backbone. On the other hand anhydride groups react with the hydroxyl groups of cellulose in the fiber, which improves the adhesion. Composites made from these materials can be used in packaging and automotive applications. However, the scope of these materials is not limited to these fields.

In one of the embodiments of the composite preparation, the natural fibers/natural fillers used in the composite preparation are bast fibers such as Hemp, flax, kenaf, sisal and leaf fibers like henequen, pine apple leaf fibers, grass fibers, but not limited to these.

In yet another embodiment, the fibers that are of particular interest in this invention are hemp, henequen, kenaf and pineapple leaf fibers.

In yet another embodiment, these fibers can be used with/without any washing, pretreatment or modifications.

In yet another embodiment, fibers are modified by alkali treatment, mercerization, silane treatment, benzoylation and peroxide treatment can also be employed to improve mechanical properties of the biofiber composites.

In yet another embodiment, the fibers used in the composite preparation can be varied from a millimeter to any continuous length depending upon the properties desired.

In yet another embodiment, the fibers can be fed manually or automatically at various rates through different port of the extruder to vary the residence time.

In yet another embodiment, the screw configurations of the extruder can be changed to attain desired residence time, fiber-matrix dispersion and adhesion. The twin-screw extruder can be incorporated with more kneading blocks to increase the residence time, and mixing of the polymer and the fiber during processing. Incorporation of left-handed elements will also increase the retention time.

In yet another embodiment, screw configurations having two and three kneading blocks are used.

In yet another embodiment, the fiber is added from different ports in the extruder to control the residence time, which in turn helps regulating the degradation of the fiber.

In yet another embodiment, the port of addition is chosen in such a manner so that the fiber has enough time to mix with the polymer, yet not degrade.

In yet another embodiment, the polymer is suitably processed in the temperatures ranging from 135°-190° C.

In yet another embodiment, the PHB-g-MA where MA is maleic anhydride, is taken in additive proportions varying from 1-15% by weight.

In yet another embodiment, the compatibilizer PHA-anhydride and the polymer matrix can be mixed together externally and added in the extruder. Alternatively, the compatibilizer can also be added separately from one of the ports of the extruder.

In yet another embodiment, the collected strands of the compatibilizer PHA anhydride can be converted in the form of powder or pellets.

The present invention is illustrated in greater detail by the specific examples presented hereinafter, but it is to be noted that these are illustrative embodiments and the invention is not to be limited by any of the details of the description, rather is to be construed broadly within its spirit and scope.

List of chemicals, solvents and polymers, fibers, etc., including sources (that are used in different Examples).

Chemicals:

1. Methanolic KOH—Aldrich®, Milwaukee, Wis., USA
2. Isopropanolic HCl—Aldrich®
3. Bromothymol blue—Fisher Scientific, NJ, USA (Headquarters, Hampton, N.H.)
4. Maleic anhydride—Aldrich®
5. CDCl₃—Cambridge Isotope company, USA
6. Octadecenyl succinic anhydride—Pentagon Chemical Specialties Ltd., UK
7. Hydrochloric acid—Aldrich®
8. KOH—Aldrich®
9. Toluene—Spectrum, USA
10. 2,5dimethyl-2,5-ditertbutyl peroxy hexane (TRIGONOX 101 45 B and LUPEROX 101)—Akzo Nobel, USA.
   Polymers:
1. Poly(3-hydroxybutyrate)—[PHB] in powder form [BIOMER]
2. Poly(3-hydroxybutyrate)—[BIOMER P226]
3. Poly(3-hydroxybutyrate-co-3-hydroxyvalerate) [PHBV]—BIOPOL XB 407, METABOLIX
   Solvents:
1. Chloroform—E. M. Science, USA
2. Methanol—Aldrich®
3. Acetone—Aldrich®
   Fibers:
1. Hemp—Canada
2. Henequen—Mexico

### Examples 1-7

### PHB(P-226)-g-MA

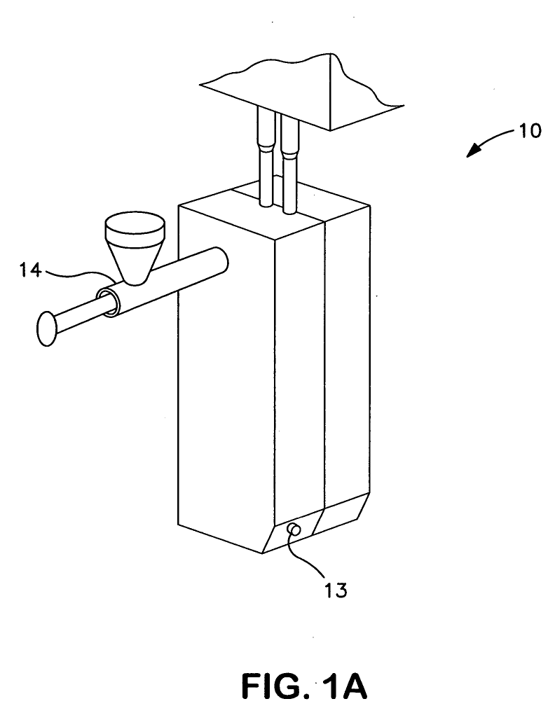

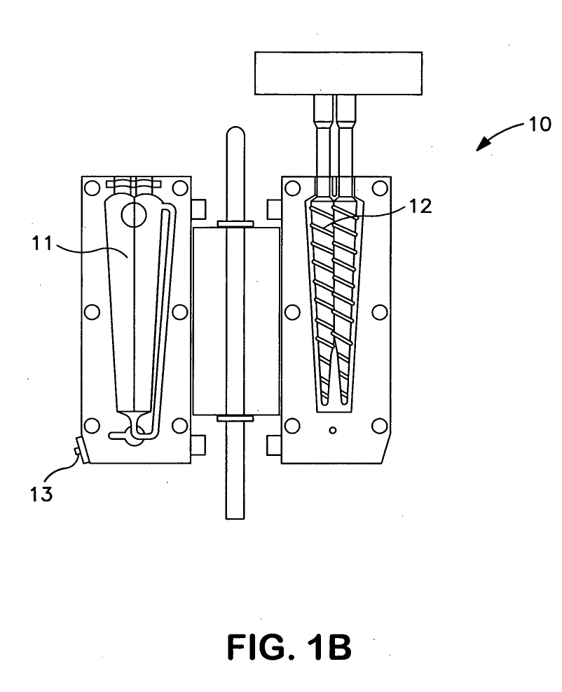

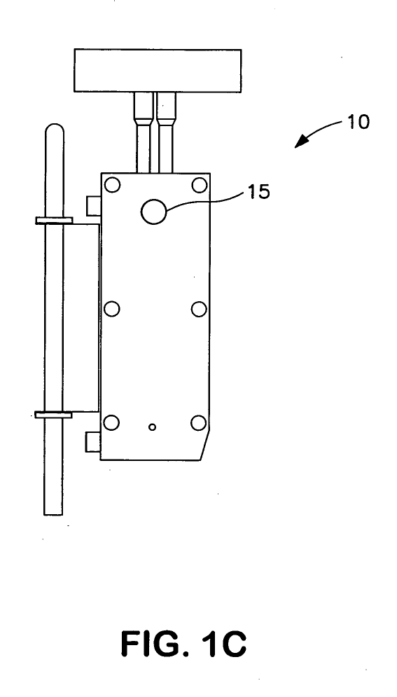

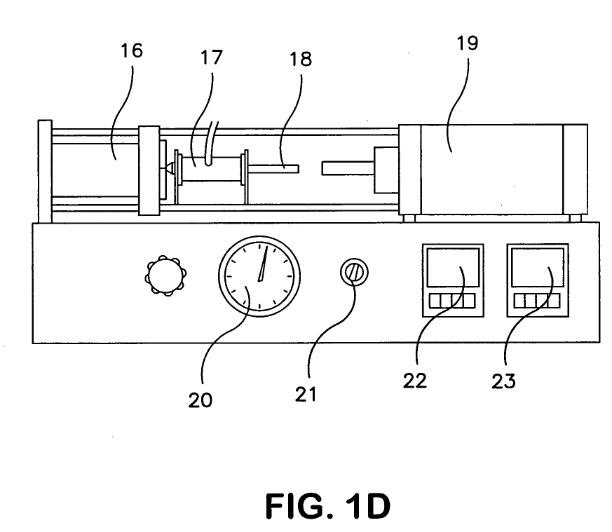

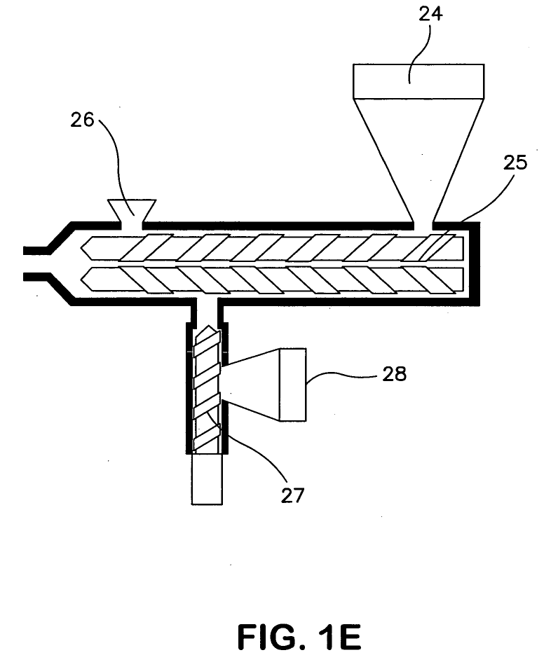

The grafting reactions were carried out using a co-rotating twin-screw extruder (DSM Micro 15, The Netherlands), as shown in FIGS. 1A to 1D. The parts are as follows:
Extruder
Barrel
Screws
Exit port
Feeder
Feeder port
Mold and mold heater
Transfer cylinder
Piston
Pneumatic piston
Pressure gauge
Piston control knob
Mold temperature controller
Transfer Cylinder temperature controller
   The large extruder 1E includes
Main hopper
Twin screw extruder
Manual addition (Port 7)
Automatic side feeder (Port 4)
Side feeder hopper

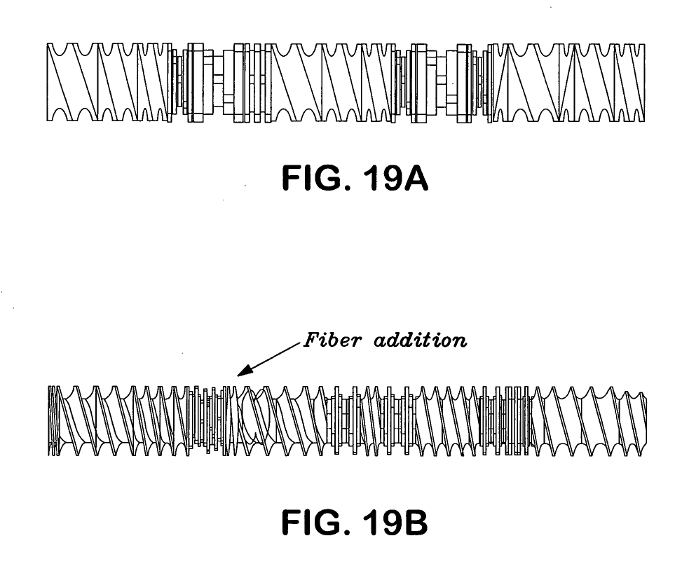

The extruder was divided into 3 zones with variable l/d and fixed barrel length. The temperature of the first, second and third zone was maintained at between 190-170° C., to obtain a melt temperature of 162±1° C. and the desired graft content. A continuous flow of nitrogen was maintained with the help of a gas inlet device attached to the extruder. A mixture of plasticized polyhydroxybutyrate (PHB)-P226, of Biomer Germany Mw=426,000, maleic anhydride (MA) from Aldrich and free radical initiator Trigonox 101 45B (2,5-dimethylhexane-2,5-ditertbutyl peroxide) supplied by Akzo Nobel in varied proportions was introduced into the extruder using a manual/auto feeder. The screw rotation speed was varied between 50 to 150 rpm and the residence time was maintained between 1-5 minutes. The extrudate was pelletized prior to further purification. The unreacted MA was removed by drying the pellets for 6-14 hrs in a vacuum oven at suitable temperature (˜80° C.). The mechanism of grafting is shown in Scheme 1. The same reaction and its results is reproduced using a large scale using ZSK 30 twin-screw extruder with/without an automatic feeder, as shown in FIGS. 1E and 19A and 19B. Some of the examples of grafting conditions of maleic anhydride onto PHB in the extruder are complied in Table 1.

TABLE 1
Reaction conditions for PHB(P-226)-g-MA.

| | | | | Barrel Zone | | | | | | | |
|---|---|---|---|---|---|---|---|---|---|---|---|
| | | MA | | Temperatures | | | Melt | | Residence | | |
| | | wt | T101 | (° C.) | | | Temp | Screw | time | Acid | Anhydride |
| Ex. | Polymer | % | wt % | Z1 | Z2 | Z3 | (° C.) | (Rpm | (min) | No. | % |
| 0 | PHB | 0 | 0 | 190 | 180 | 172 | 162 | 75 | 2 | 2.5 | — |
| 1 | PHB | 4 | 0.9 | 190 | 180 | 172 | 162 | 75 | 2 | 5 ± 1 | 0.2 |
| 2 | PHB | 4 | 1.35 | 190 | 180 | 172 | 162 | 75 | 2 | 14 ± 2 | 1.2 ± 0.2 |
| 3 | PHB | 4 | 1.8 | 190 | 180 | 172 | 162 | 75 | 2 | 18 ± 2 | 1.4 ± 0.2 |
| 4 | PHB | 4 | 1.8 | 190 | 180 | 172 | 162 | 100 | 3 | 23 ± 2 | 2.0 ± 0.2 |
| 5 | PHB | 6 | 1.35 | 190 | 180 | 172 | 162 | 75 | 2 | 37 ± 2 | 3.5 ± 0.2 |
| 6 | PHB | 8 | 1.35 | 190 | 180 | 172 | 162 | 75 | 2 | 47 ± 3 | 4.0 ± 0.2 |
| 7 | PHB | 8 | 1.8 | 190 | 180 | 172 | 162 | 100 | 3 | 44 ± 5 | 3.8 ± 0.2 |

*T 101 is Trigonox 101 45 B (2,5-bis(tert-butyl peroxy)-2,5-dimethylhexane) on solid support (talc)

The acid number and amount of anhydride grafted on the PHB back-bone was determined by direct titration. The anhydride content and acid number of the grafted polymer was determined by titration of the acid groups derived from anhydride functional groups by using the procedure outlined in the literature (Chen et al., J. Appl. Polym. Sci., 88, 659 (2003)). 1.0-2.0 g purified maleated PHB was refluxed with 150 mL of chloroform for 1 h to complete dissolution. The hot solution was titrated against 0.103 N methanolic KOH using bromothymol blue in dimethyl formamide (1%) as an indicator. A known excess of methanolic KOH was added, and the deep-blue color was back-titrated to a yellow end point by the addition of 0.118 N pre-standardized hot methanolic HCl. A blank titration was also carried out in the same way in absence of maleated PHB. The acid number and % anhydride were calculated using the following equations:
Acid number=V_{KOH}×N_{KOH}×56.1/W
% Anhydride=V_{KOH}×N_{KOH}×98.06/2×W×100
where W is the weight of the sample.
¹H and ¹³C NMR of PHB(P-226)-g-MA

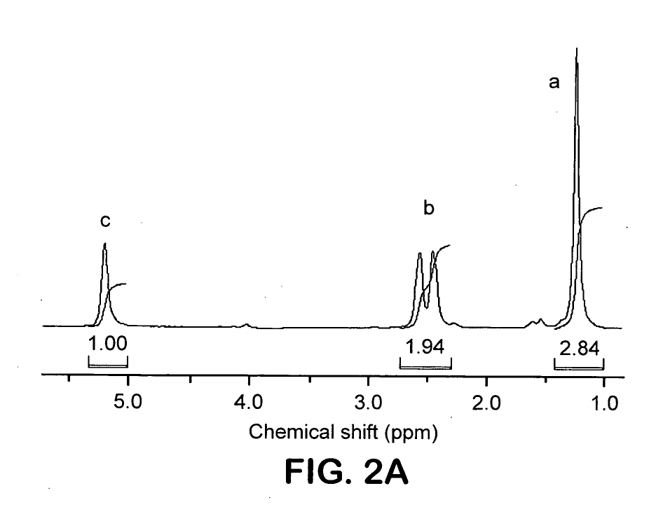

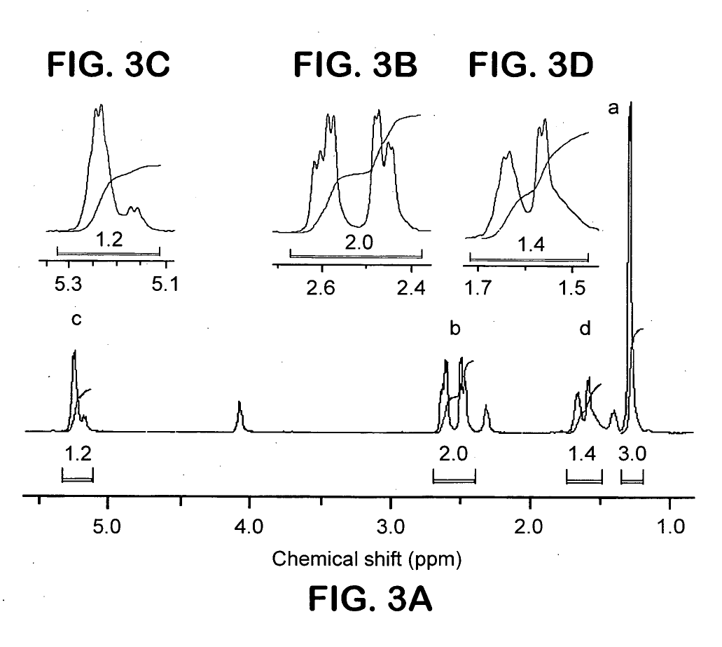

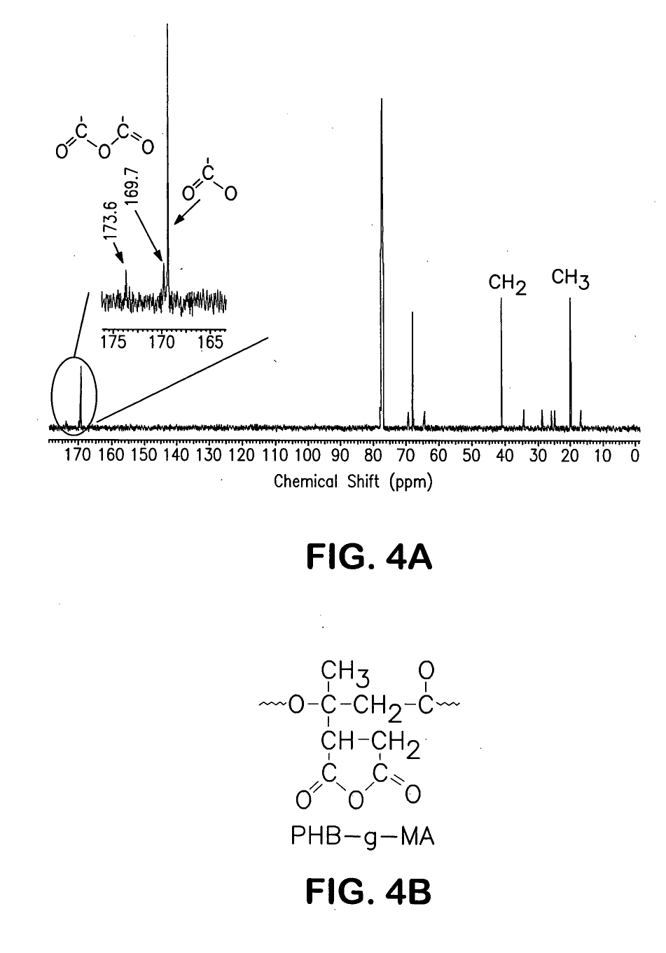

The ¹H NMR spectra of PHB(P-226) and PHB(P-226)-g-MA are presented in FIGS. 2 and 3, respectively. Accordingly the peaks at a=1.27 ppm (singlet), b=2.45-2.6 ppm (doublet) c=5.24 ppm (singlet) in FIG. 2 correspond to CH₃, CH₂ and CH in the PHB back bone and emergence of new peaks at b=2.45-2.6 ppm (double doublet), c=5.3 ppm (double doublet), d=1.2-1.4 ppm (double doublet) in FIG. 3, are the result of the formation of PHB-g-MA. The absence of peak at δ=67.6 ppm in the ¹³C NMR (FIG. 4) of maleated PHB indicates grafting taking place via hydrogen abstraction from C—H in the PHB backbone. Appearance of new peaks at δ=29.7 and 43.2 ppm corresponding to methylene and methine of the anhydride ring reaffirms grafting of maleic anhydride onto the PHB chains. The absence of a peak at 136 ppm in the C¹³ NMR (FIG. 4) of PHB-g-MA reaffirms the grafting through unsaturation in the MA ring and further supports the fact the there is no unreacted MA is left in the matrix.

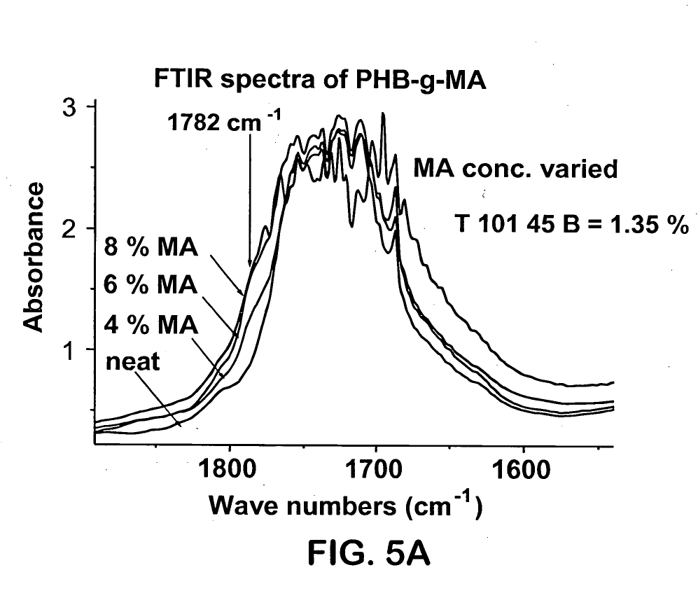

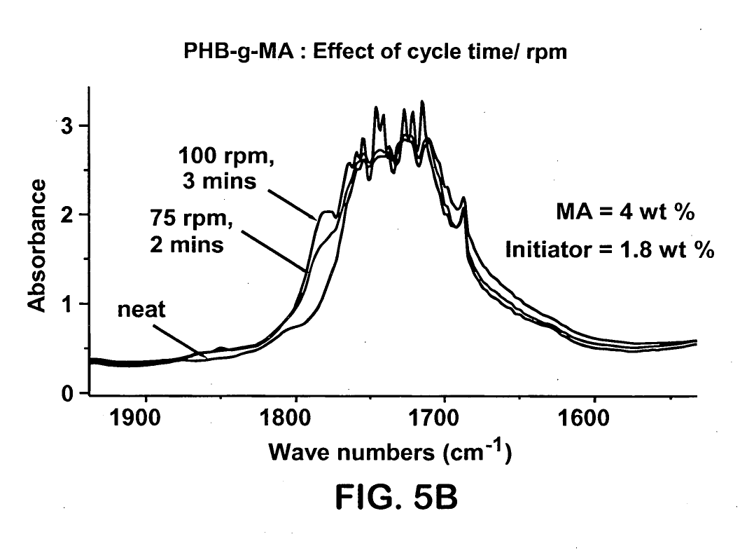

Generation of anhydride peak from grafted maleic anhydride can be determined from the peak at 1782 cm¹ in the FTIR spectra (FIGS. 5A and 5B).

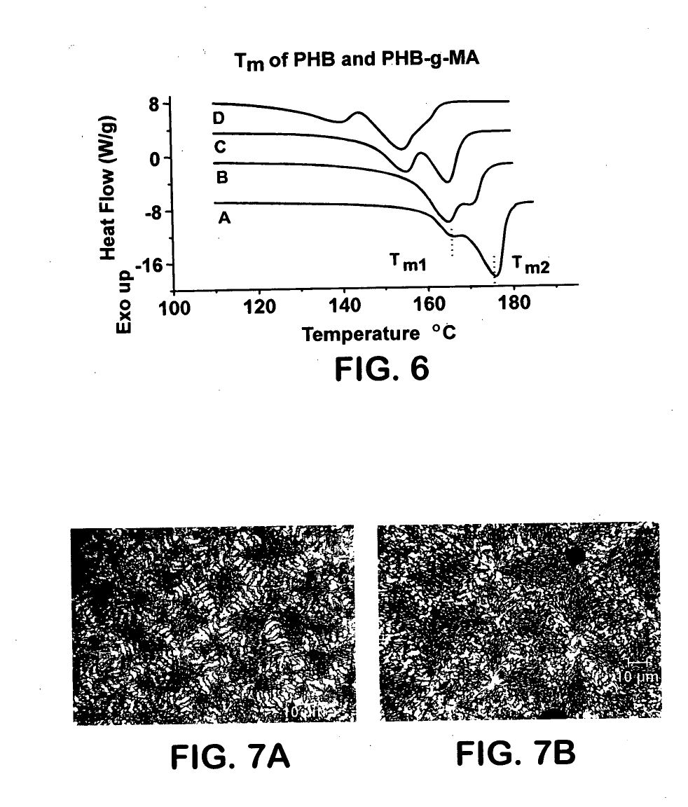

Decrease in the Tₘ with increase in the monomer concentration is a further indication of grafting (FIG. 6). Grafting of anhydride groups on to the PHB backbone introduces imperfect crystals, which melt at lower temperature. Thus, lowering of the Tₘ further confirms the grafting of MA onto the PHB backbone.

The hypothesis of imperfect crystal formation upon grafting is supported by the optical microscopy results (FIGS. 7A and 7B).

### Example 8-13

### (PHB-g-ODSA)

Using the similar experiment conditions mentioned in example 1-7, grafting reaction was carried out taking plasticized PHB (P-226), octadecenyl succinic anhydride Pentagon Co., UK, and suitable free radical initiator (Trigonox 101 45 B) in varying proportions. Different reaction conditions are compiled in Table 2.

TABLE 2
Reaction conditions for PHB(P-226)-g-ODSA.

| | PHB(P- | Initiator | | | Screw | Residence | | Anhydride |
|---|---|---|---|---|---|---|---|---|
| | 226) | T101* | ODSA | Melt Temp. | speed | time | Acid | Graft |
| Ex | (gm) | (wt %) | (wt %) | (° C.) | (rpm) | (min.) | Number | (%) |
| 8 | 10.0 | 1.8 | 4.0 | 163 ± 1 | 100 | 3 | 7 | 0.6 |
| 9 | 10.0 | 1.8 | 6.0 | 163 ± 1 | 100 | 3 | 11 | 0.8 |
| 10 | 10.0 | 1.8 | 8.0 | 163 ± 1 | 100 | 3 | 14 | 1.3 |
| 11 | 10.0 | 1.35 | 6.0 | 163 ± 1 | 100 | 3 | 12 | 1.2 |
| 12 | 10.0 | 1.35 | 10 | 163 ± 1 | 100 | 3 | — | — |
| 13 | 10.0 | 1.35 | 15 | 163 ± 1 | 100 | 3 | — | — |

The acid number and % anhydride in the polymer backbone confirm the grafting of ODSA onto the PHB(P-226) chains.

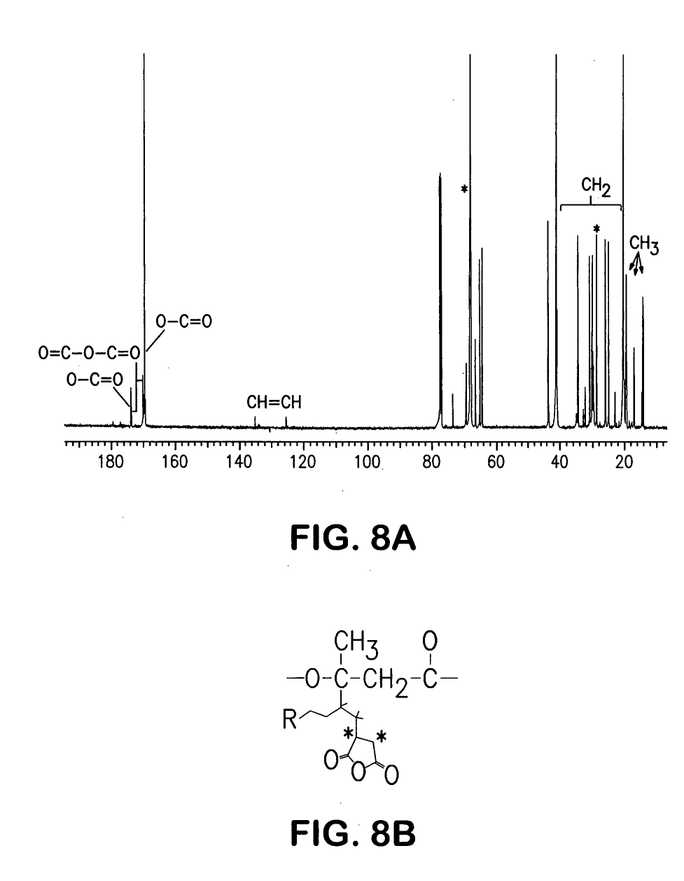

FIG. 8A. ¹³C NMR spectrum of PHB(P-226)-g-ODSA the ¹³C NMR spectra emergence of new peaks at 170, 173.6 responding to CH₂ and CH of anhydride group in PHB(P-)-g-ODSA (FIG. 8B) also substantiate the grafting of ODSA on to the PHB chains. These peaks are compiled in

TABLE 3

| | δppm | | | | | |
|---|---|---|---|---|---|---|
| | | | | | Ester | Anhydride |
| Sample | CH₃ | CH₂ | CH | HC═CH | O—C═O | C═O |
| PHB-g- | 13.8, | 28.5, | 67.8 | Almost | 169.2, | 170.1, |
| ODSA | 19.9, | 41.5 | | nil | 169.8, 173.8 | 173.6 |
| | 23.0 | | | | | |

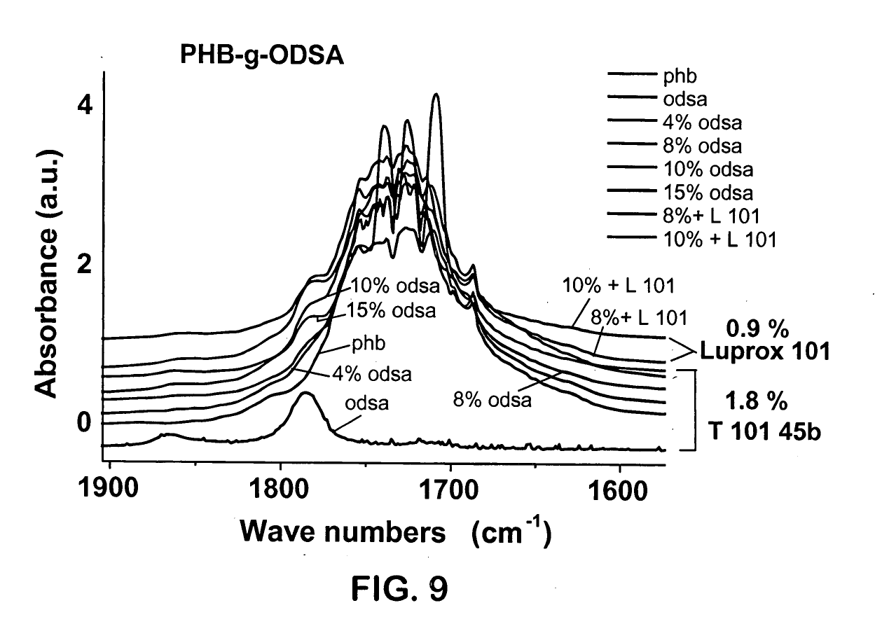

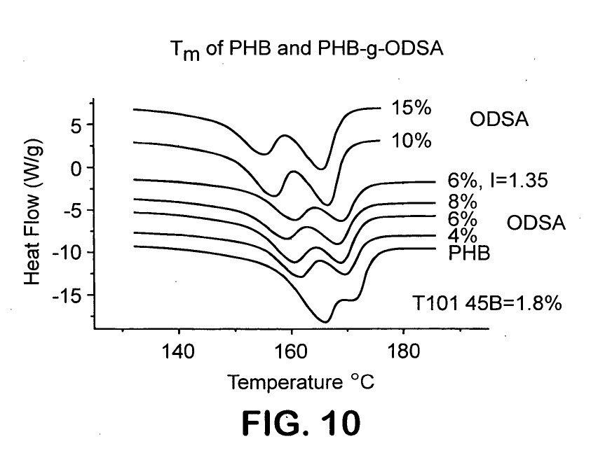

FTIR spectra of PHB(P-226)-g-ODSA with various ODSA and initiator concentrations are shown in FIG. 9. Generation of anhydride peaks at 1782 cm⁻¹ confirms DSC grafting thermograms showing Tm of various samples; PHB(P-226) and PHB(P-226)-g-ODSA with various ODSA and initiator concentrations are also shown in FIG. 10. Decrease in Tm with increase in the monomer and initiator concentrations confirms the grafting of ODSA onto PHB backbone.

### Example 14-17

### (PHB(P-226)-g-ODSA)

Using the similar experiment conditions mentioned in Examples 1 to 7, grafting reaction was carried out taking a mixture of plasticized (PHB(P-226)) and unplasticized PHB (PHB), octadecenyl succinic anhydride, and suitable liquid free radical initiator in varying proportions. Reaction conditions for some of the experiments are compiled in Table 4.

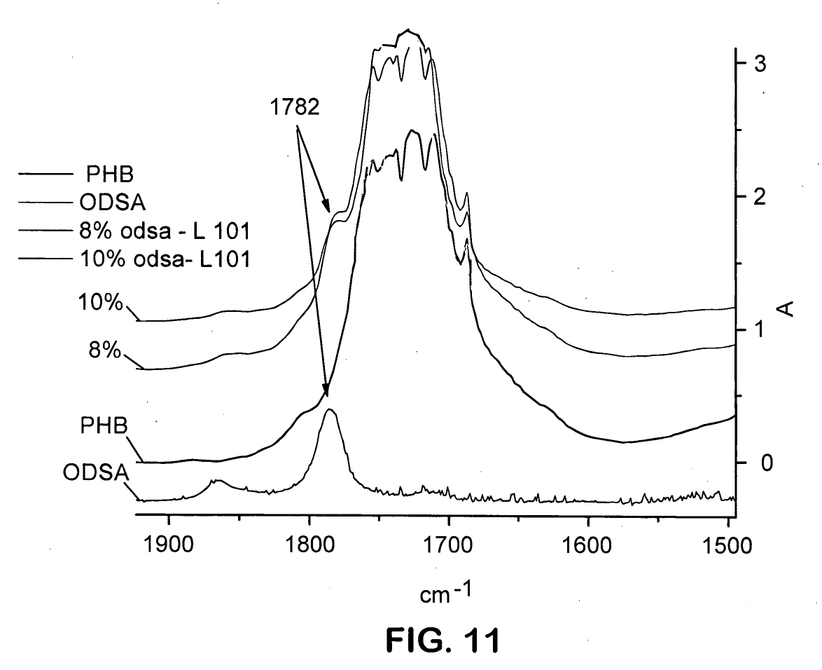

FTIR spectra of PHB(P-226) and PHB(P-226)-g-ODSA using liquid initiator (L 101) are shown in FIG. 11. Generation of anhydride peaks at 1782 cm⁻¹ in the FTIR spectra confirms grafting.

TABLE 4.

| | PHB(P- | | | | | |
|---|---|---|---|---|---|---|
| | 226): | Initiator | | Melt | Screw | Residence |
| | PHB | L101 | ODSA | Temp. | speed | time |
| Ex. | (gm) | (wt %) | (wt %) | (° C.) | (rpm) | (min.) |
| 14 | 70:30 | 0.9 | 8 | 163 ± 1 | 100 | 3 |
| 15 | 70:30 | 0.9 | 10 | 163 ± 1 | 100 | 3 |
| 16 | 60:40 | 0.9 | 8 | 163 ± 1 | 100 | 3 |
| 17 | 80:20 | 0.9 | 10 | 163 ± 1 | 100 | 3 |

*L 101 is Luperox 101 (2,5-bis(tert-butyl peroxy)-2,5-dimethylhexane) liquid initiator.

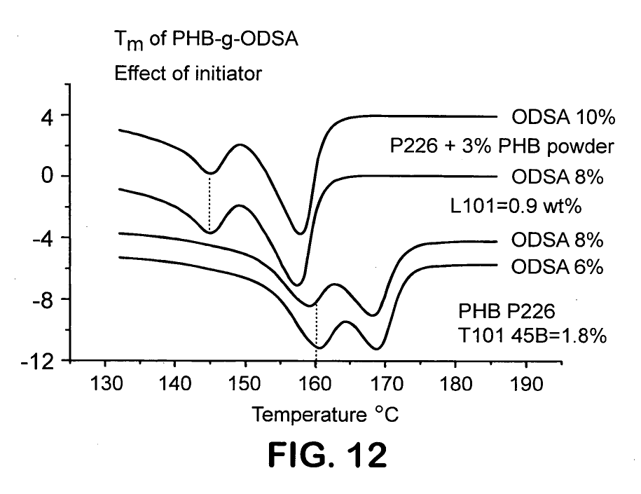

Tm values of PHB(P-226)-g-ODSA at different ODSA concentrations are shown in FIG. 12. Decrease in the Tₘ with increase in the % anhydride incorporation in PHB backbone is a further indication of grafting. Grafting of anhydride groups on to the PHB backbone introduces imperfect crystals, which melt at lower temperature. Thus, lowering of the Tₘ further confirms the grafting of ODSA onto the PHB backbone.

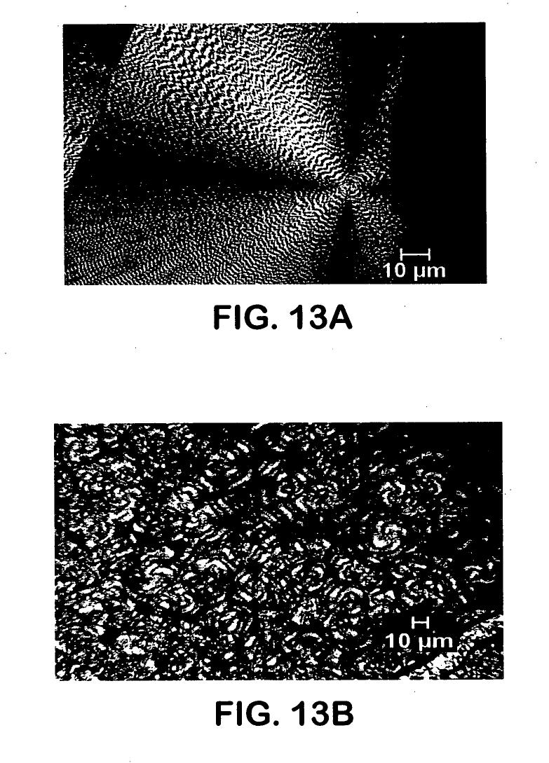

A significant difference in the crystal size and spherulite shape and morphology is apparent from the optical micrographs. This further supports the grafting on PHB (FIGS. 13A and 13B).

### Examples 18 to 20

### (PHBV-g-MA)

Using the similar experiment conditions mentioned in Examples 1 to 7, grafting reaction was carried out taking varying proportions of PHBV(MBX BIOPOL XB 407 from Metabolix, Mass., USA), maleic anhydride Aldrich, and Trigonox 101 45B Akzo Nobel, free radical initiator. Different reaction conditions are compiled in Table 5.

| | | Initiator | | | Screw | Residence | | |
|---|---|---|---|---|---|---|---|---|
| | PHBV | T101 | MA | Melt Temp. | speed | time | Acid | Anhydride |
| Ex. | (gm) | (wt %) | (wt %) | (° C.) | (rpm) | (min.) | No. | % |
| 18 | 10 | 1.8 | 4 | 163 ± 1 | 100 | 3 | 15 | 1.0 |
| 19 | 10 | 1.8 | 6 | 163 ± 1 | 100 | 3 | 20 | 1.5 |
| 20 | 10 | 1.8 | 8 | 163 ± 1 | 100 | 3 | 24 | 2.0 |

*T 101 is Trigonox 101 45 B (2,5-bis(tert-butyl peroxy)-2,5-dimethylhexane) on solid support

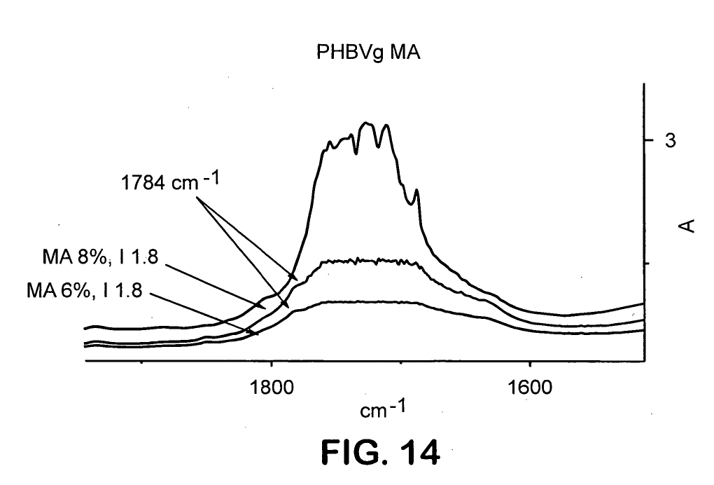

FIG. 14 shows FTIR spectra of PHBV-g-MA at different MA concentration. Generation of new peaks (anhydride) at 1784 cm⁻¹ in the FTIR spectra confirms grafting.

The above Examples 18 to 20 describe the process for the preparation of maleated PHAS, which is illustrative only and should not be constructed, to the scope of the present invention in any manner.

Furthermore, the details of composite preparation from PHAs and different natural fibers/natural fillers, in varying proportion, in presence and absence of compatibilizers are presented as Examples below, but it is to be noted that these are illustrative embodiments and the invention is not to be limited by any of the details of the description but rather is to be construed broadly within its spirit and scope.

Extrusion Processing of PHB(P-226) Composites.

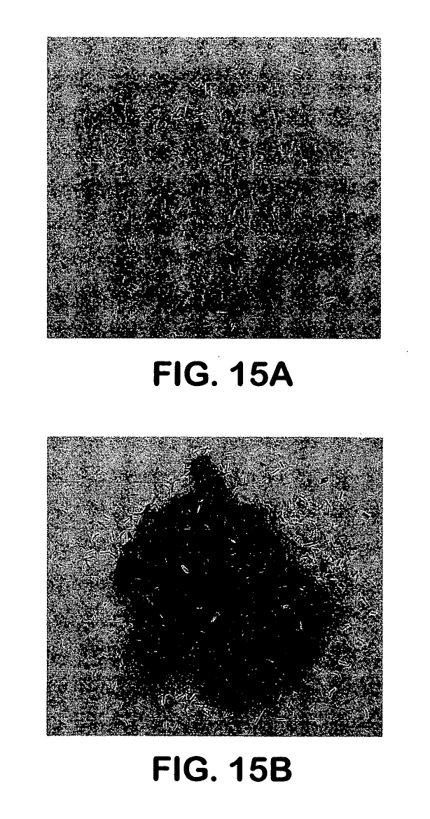

PHB(P-226) and natural fibers (FIGS. 15(a) and (b)) were pre-dried in the vacuum oven for 3 hours at 30 KPa and 80° C. to remove moisture. The polymer and the fiber were then extruded in a twin-screw extruder ZSK 30 (Werner Pfleiderer) as in FIG. 1E with preset zone temperatures, which can be individually controlled (Zone 1 to 6: 185° C.-180° C.-175° C.-170° C.-165° C.-135° C.) throughout the processing cycle. The die temperature was set at 1350 to enable easy collection of the composite strands.

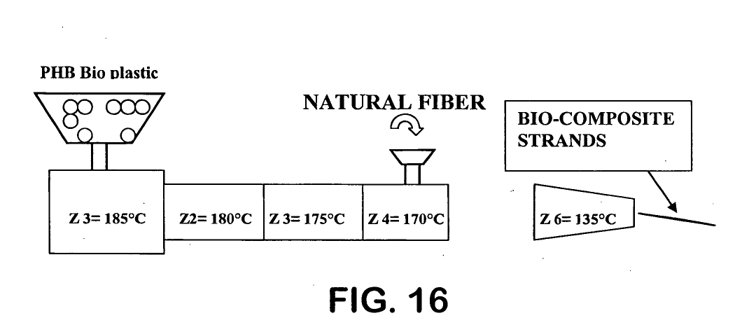

The processing of PHB(P-226)/fiber composites is schematically represented in FIG. 16. The PHB pellets were added through an automatic K-tron feeder attached to the extruder and the fiber was added manually through port 4 (FIG. 16). The feeder was calibrated to feed 40-gm/min, while fiber fed rate was set at 17-gm/min and 27 gm/min for 30-wt % and 40-wt % reinforcement, respectively. In order to improve the properties of the composites PHB(P-226)-g-MA was added as a compatibilizer in varying proportions. The PHB (P-226)-g-MA compatibilizer prepared by reactive extrusion in DSM mini-extruder, which was discussed earlier, was pelletized, purified and added to PHB(P-226), followed by homogenizing this mixture using a kitchen blender. This mixture was transferred to feeder of the extruder, where it is processed and the strands are obtained for further injection molding. The extruder screw speed and torque were set at 100 rpm and 40-60%, respectively through out the processing. Polymer strands were collected and palletized FIGS. 17(a) and (b) before injection molding.

Injection Molding of PHB(P-226) Composites:

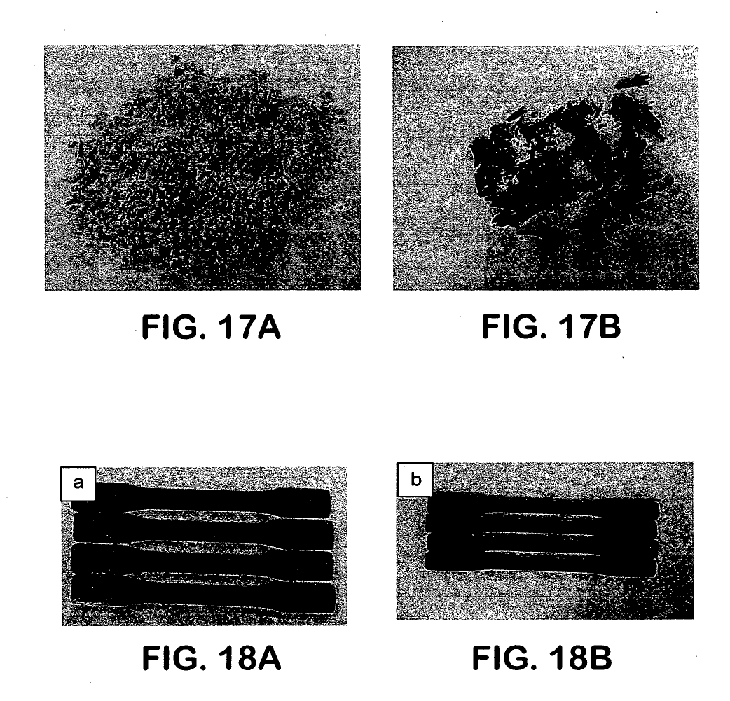

The above composites were injection molded in a cincinatti-millacron press of 85-ton capacity. The injection molder has four zones each of which can be individually controlled. The zone temperatures were maintained at Zone 1 to 4: 375° F., 345° F., 340° F. and 335° F. for all the composites. The mold temperature was set at 70° F. Standard tensile coupons FIGS. 18(a) and (b) were obtained for mechanical property evaluation.

The following examples describe the process for the preparation of natural fiber/natural fillers composites with PHAs, which is illustrative only and should not be constructed, to the scope of the present invention in any manner.

### Examples 20 to 27

### Extrusion and Injection Molding Processing of PHB(P-226)/hemp Fiber Composites with Varying Proportions of Compatibilizer and Fiber Content

The Examples 20 to 23 show the amount of PHB-g-MA in the PHB(P-226)/30 wt % hemp fiber composites. The processing conditions and the processing method are already explained. Examples 24 to 26 show the amount of PHB-g-MA in PHB(P-226)/40 wt % composites. Example 27 shows the compatibilization of PHB(P-226)/50 wt % hemp fiber composites. These compositions are shown in Table 6 & Table 7. The injection molding conditions of these composites are given in Tables 8 & 9.

TABLE 6
Composition of PHB-g-MA in 30 wt % hemp fiber
composites.

| | PHB(P- | | |
|---|---|---|---|
| | 226) | PHB-g-MA | Hemp |
| Ex | (wt %) | (wt %) | (wt %) |
| 20 | 100 | — | — |
| 21 | 70 | — | 30 |
| 22 | 68 | 2 | 30 |
| 23 | 65 | 5 | 30 |

TABLE 7
Composition of PHB-g-MA in 40 wt % Hemp fiber composites.

| | PHB(P- | PHB-g-MA | |
|---|---|---|---|
| Example | 226) (wt %) | (wt %) | Hemp (wt %) |
| 20 | 100 | — | — |
| 24 | 60 | — | 40 |
| 25 | 58 | 2 | 40 |
| 26 | 55 | 5 | 40 |
| 27 | 45 | 5 | 50 |

TABLE 8
Injection molding conditions of 30 wt % hemp fiber composites
(Examples 20-23).

| | Fill Pressure | Pack Pressure | Hold Pressure | Shot Size |
|---|---|---|---|---|
| Example | (psi) | (psi) | (psi) | (inches) |
| 20 | 400 | 350 | 350 | 0.95 |
| 21 | 600 | 550 | 550 | 1.03 |
| 22 | 600 | 550 | 550 | 1.02 |
| 23 | 600 | 550 | 550 | 1.02 |

TABLE 9
Injection molding conditions of 40 wt % hemp fiber composites
(Examples 24-27).

| | Fill Pressure | Pack Pressure | Hold Pressure | Shot Size |
|---|---|---|---|---|
| Example | (psi) | (psi) | (psi) | (inches) |
| 20 | 400 | 350 | 350 | 0.95 |
| 24 | 800 | 750 | 750 | 1.05 |
| 25 | 800 | 750 | 750 | 1.05 |
| 26 | 800 | 750 | 750 | 1.05 |
| 27 | 1000 | 900 | 900 | 1.05 |

Mechanical Property Evaluation:

The coupons obtained from injection molder were used for tensile, flexural and impact property measurements. United Calibration Corp SFM 20 was used to measure the tensile strength and modulus of elasticity, according to ASTM D 638 standard. The flexural strength and modulus of elasticity were measured according to ASTM D 790. A two inch laser extensometer was used to measure extension of the specimen during the test.

A Testing Machines Inc (TMI) 43-OA-01 machine was used for Notched Izod impact testing. The impact test was carried out according to ASTM D 256 standard. For this test the coupons were cut into 2.5 inches×0.5 inches×0.125 inches.

Results of Mechanical Properties of Examples 20 to 27

Table 10 shows the tensile strength of the 30-wt % fiber reinforced composites. The modulus of the composites doubled with the addition of 30-wt % fiber and the modulus further increased by 17% and 50% with the addition of 2% and 5% compatibilizer (PHB-g-MA) respectively (PHB-g-MA) The increase in modulus suggests that the compatibilizer is acting as a very good link between the fiber and the matrix.

The strength did not improve much with the addition of the fiber but with the addition of compatibilizer there was an improvement in the strength in 40-wt % fiber reinforcement.

It can be seen from the Table 11 that the modulus of the composite increased with 40 wt % fiber reinforcement. The addition of 5 wt % PHB-g-MA further increased the modulus of the composite.

However there was not much increase in the strength of the composites with and with out compatibilizer. The tensile strength and Modulus of the PHB(P-226) 50 wt % hemp composites were less compared to that of the 40-wt % composites. The main intention of adding 50%-wt fiber in the composite was to decrease the cost rather than increasing the properties.

TABLE 10
Tensile strength and modulus of 30%-wt composites
(Examples 20 to 23).

| | Average Tensile | Average Tensile |
|---|---|---|
| Example | Strength (MPa) | Modulus(GPa) |
| 20 | 17.9 ± 2.1 | 1.7 ± 0.1 |
| 21 | 14.9 ± 4.8 | 3.4 ± 0.4 |
| 22 | 25.8 ± 1.9 | 4 ± 0.34 |
| 23 | 29.3 ± 0.35 | 5.2 ± 0.3 |

TABLE 11
Tensile strength and modulus of 40% wt and 50 wt %
composites (Examples 24 to 27).

| | Average Tensile | Average Tensile |
|---|---|---|
| Example | Strength (MPa) | Modulus(GPa) |
| 20 | 17.9 ± 2.1 | 1.7 ± 0.1 |
| 24 | 23.7 ± 0.7 | 6.0 ± 0.5 |
| 25 | 16.14 ± 2.8 | 3.8 ± 0.2 |
| 26 | 29.9 ± 0.6 | 6.3 ± 0.4 |
| 27 | 28.7 ± 2.2 | 5.3 ± 0.2 |

Table 12 shows the Flexural strength of the PHB(P-226)/30 wt % Hemp fiber composites. The flexural strength of the composites increased with the addition of hemp fiber and there was a further increase in the strength with the addition of compatibilizer. The modulus of the composites increased with the addition of the fiber but there was no change in the modulus with the addition of the compatibilizer.

TABLE 12
Flexural strength and modulus of 30%-wt of fiber
composites (Examples 20 to 23).

| | Average Flexural | Average Flexural |
|---|---|---|
| Example | Strength (MPa) | Modulus(GPa) |
| 20 | 33.5 ± 0.56 | 1.7 ± 0.1 |
| 21 | 39.4 ± 0.92 | 4.8 ± 0.1 |
| 22 | 46.5 ± 0.4 | 4.6 ± 0.12 |
| 23 | 48.1 ± 0.7 | 4.5 ± 0.13 |

Table 13 shows the Flexural strength and modulus of the PHB(P-226)/40 wt % and 50 wt % hemp fiber composites The modulus of the composites increased with incorporation of 40 wt % and the there was a significant improvement in the modulus with the addition of 5 wt % compatibilizer. The modulus of the composite increased in presence of 50 wt % fiber and 5 wt % compatibilizer.

TABLE 13
Flexural strength and modulus of 40 wt % and 50
wt % fiber composites (Examples 24 to 27).

| | Average Flexural | Average Flexural |
|---|---|---|
| Composite Type | Strength (MPa) | Modulus (GPa) |
| 20 | 33.5 ± 0.6 | 1.7 ± 0.1 |
| 24 | 43.2 ± 1.6 | 5.5 ± 0.2 |
| 25 | 45.8 ± 1.4 | 5.2 ± 0.2 |
| 26 | 54.3 ± 1 | 6.6 ± 0.2 |
| 27 | 51.8 ± 0.8 | 7.5 ± 0.1 |

Tables 14 and 15 show the impact strength of the PHB(P-266) composites. It can be seen from the above that the tensile and flexural properties of the composites increased with fiber reinforcement and compatibilization. However the impact properties of the composites did not change.

TABLE 14
Impact strength of 30 wt % of fiber composites
(Examples 20 to 23).

| | Average Impact |
|---|---|
| Composite Type | Strength (J/m)) |
| 20 | 23.5 ± 0.2 |
| 21 | 31 ± 0.8 |
| 22 | 28 ± 1.8 |
| 23 | 30 ± 1.2 |

TABLE 15
Impact strength of 40%-wt and 50%-wt composites
(Examples 24 to 27).

| | Average Impact |
|---|---|
| Composite Type | Strength (J/m) |
| 20 | 23.5 ± 0.2 |
| 24 | 29.5 ± 1.7 |
| 25 | 31 ± 1 |
| 26 | 32 ± 0.5 |
| 27 | 24.7 ± 1 |

### Examples 28 to 29

(Extrusion and Injection molding processing of PHB(P-226)/henequen fiber composites with varying proportions of compatibilizer content). Table 16 shows the proportions of PHB(P-226)-g-MA in PHB(P-226)/henequen fiber composites.

| | PHB(P- | PHB(P-226)-g- | |
|---|---|---|---|
| | 226) | MA | Henequen |
| Example | (wt %) | (wt %) | (wt %) |
| 20 | 100 | — | — |
| 28 | 70 | — | 30 |
| 29 | 65 | 5 | 30 |

Results of Mechanical Properties of Examples (28 to 29)

Table 17 shows the tensile properties of the PHB(P-226)/30 wt % henequen fiber composites. There was a great improvement in the modulus and the strength of the composites with fiber reinforcement but there was a slight change increase in the properties with the addition of PHB(P-266)-g-MA.

| | Average Tensile | Average Tensile |
|---|---|---|
| Example | Strength (MPa) | Modulus(GPa) |
| 20 | 17.9 ± 2.1 | 1.7 ± 0.1 |
| 28 | 19.4 ± 0.25 | 3.4 ± 0.4 |
| 29 | 19.4 ± 0.6 | 3.5 ± 0.2 |

Table 18 shows the flexural strength and modulus of the PHB(P-226)/henequen fiber composites. It can be seen from the table that both the addition of fiber as well as the compatibilizer increased the flexural modulus. However, the strength did not change with the addition of compatibilizer.

| | Average Flexural | Average Flexural |
|---|---|---|
| Example | Strength (MPa) | Modulus(GPa) |
| 20 | 33.5 ± 0.56 | 1.7 ± 0.1 |
| 28 | 35.1 ± 0.2 | 3.5 ± 0.3 |
| 29 | 31.2 ± 0.5 | 3.9 ± 0.13 |

Table 19 Shows the Impact strength of the PHB(P-226)/henequen fiber composites. There was not much change in the impact strength of the composites with the addition of the compatibilizer.

| | Average Impact |
|---|---|
| Composite Type | Strength (J/m) |
| 20 | 23.5 ± 0.2 |
| 28 | 58 ± 0.6 |
| 29 | 50.4 ± 3.6 |

Example 30 shows the preparation of PHB(P-226)/30 wt % fiber composites using PHB(P-226)-g-MA as a compatibilizer with automatic addition of fiber in the extruder. The processing conditions and the proportions were similar except the mode of addition of the fiber and the fiber port from which the fiber was added. FIG. 19 shows the schematic of manual and automatic addition of the fiber in to the extruder.

The screw configuration used in the automatic addition was different from the one used in the Examples 20-29. FIGS. 20(a) and (b) shows these screw comparisons. The automatic addition is done using a side feeder.

The screw configuration of the extruder can be changed to obtain the desired properties of the composites. Change in extruder feeding port, adding extra kneading blocks, controlling the residence time are some of the parameters that can change the properties of the composites. In this present invention, it was desired to evaluate these changes in the properties by changing the screw configuration and feed port in the extruder.

TABLE 20
Tensile properties of PHB(P-226)/30 wt % henequen
fiber composites with automatic addition.

| | Average Tensile | Average Tensile |
|---|---|---|
| Example | Strength (MPa) | Modulus (GPa) |
| 20 | 17.9 ± 2.1 | 1.7 ± 0.1 |
| 30 | 18.1 ± 0.3 | 3.9 ± 0.5 |

TABLE 21
Flexural properties of PHB(P-226)/30 wt %
henequen fiber composites with automatic addition.

| | Average Flexural | Average Flexural |
|---|---|---|
| Example | Strength (MPa) | Modulus (GPa) |
| 20 | 33.5 ± 0.56 | 1.7 ± 0.1 |
| 30 | 33.7 ± 0.4 | 3.9 ± 0.3 |

TABLE 22
Impact properties of PHB(P-226)/30 wt % henequen
fiber composites with automatic addition.

| | Average Impact |
|---|---|
| Composite Type | Strength (J/m) |
| 20 | 23.5 ± 0.2 |
| 30 | 53 ± 2 |

It is intended that the foregoing description be only illustrative of the present invention and that the present invention be limited only by the hereinafter appended claims.

1. A composite composition prepared by a method which comprised premixing of a PHA polymer with a PHA grafted with pendant anhydride groups as a compatibilizer a dried fiber which reacts with the compatibilizer in a blender at room temperature with purging in a mechanical mixing device with its internal temperature set above the melting point of the polymer and below the degradation temperature of any of the components of the composite, having single or multiple ports and manual or automatic purging facility, and the fiber is added through one of these ports.

2. The composite of claim 1 wherein the fiber is bast or leaf fiber or any other cellulosic filler or fiber.

3. The composite of claim 2 wherein the fiber is hemp, kenaf, sisal or flax.

4. The composite of claim 2 wherein the fiber is henequen or pineapple leaf fiber.

5. The composite of claim 2 wherein the fiber is a native grass fiber.

6. The composite of claim 2 wherein the fiber is a synthetic cellulose fiber.

7. The composite of claim 2 wherein the fiber is wood flour.

8. The composite of claim 1 wherein a concentration of the compatibilizer is between 1 to 12 weight percent (wt %).

9. The composite of claim 1 wherein the fiber is varied between about 5 to 50 wt. %.

10. The composite of claim 1 is in the form of pellets, strands or powder.

11. The composite material of claim 1 molded into various shapes by placing the composite in a suitable mold at a working temperature and pressure for the molding.

12. The composite of claim 1 wherein the polyhydroxyalkanoate (PHA) grafted with the pendent anhydride of the formula I 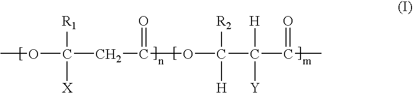
wherein X and Y are each individually selected from the group consisting of an alkyl, cycloalkyl, aryl group containing 1 to 20 carbon atoms linked to an anhydride moiety, wherein if R₁ is equal to R₂ as a homopolymer then n is equal to m and are between about 100 to 1000, and wherein if R₁ is not equal R₂ as a co-polymer, then n and m are from about 100 to 800, but are not restricted to these numbers.

13. The composite of claim 1 wherein the polyhydroxyalkanoate grafted with the pendant anhydride of claim 1 having general formula (I) 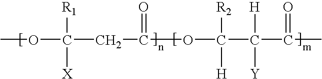
wherein R₁ is methyl, ethyl, C₁ to C₁₂ alkyl (linear and branched), R₂ is C₁ to C₁₂ alkyl (linear and branched) and X is grafted anhydride selected from the group consisting of maleic anhydride, octadecenyl succinic anhydride, nadic anhydride, and ring substituted derivatives thereof, Y is hydrogen, is grafted anhydride selected from the group consisting of maleic anhydride, succinic anhydride, octadecenyl succinic anhydride, nadic anhydride, and ring substituted derivatives thereof, and wherein if R₁ equals R₂ as a homopolymer then n equals m and are between about 100 to 1000, and wherein if R₁ is not equal R₂ as a copolymer then m and n are from between about 100 to 800, but are not restricted to these numbers.

14. A process for the preparation of a composite of a grafted polyhydroxyalkanoate (PHA) compatibilizer of claim 1 bearing the pendant anhydride groups, which comprises of mixing together (1) an anhydride, (2) free radical initiator and (3) a PHA polymer at a temperature where the PHA melts; and mixing the compatibilizer with PHA and a dried biodegradable fiber which reacts with the compatibilizer.

15. The process of claim 14 wherein the PHA is a homopolymer or a copolymer.

16. The process of claim 14 wherein the free radical initiator is selected from the group consisting of organic peroxy compounds and azo compounds.

17. The process of claim 16 wherein the organic peroxy compound is selected from group consisting of peroxides, hydroperoxides, peroxy esters and ketone peroxides.

18. The process of claim 15 wherein the PHA is poly(3-hydroxy butyrate) as a homopolymer.

19. The process of claim 15 wherein the PHA is poly(3-hydroxy velarate) as a homopolymer.

20. The process of claim 15 wherein the PHA is poly(3-hydroxypropionate) as a homopolymer.

21. The process of claim 15 wherein the PHA is poly(3-hydroxycaproate) as a homopolymer.

22. The process of claim 15 wherein the PHA is poly(3-hydroxyoctanoate) as a homopolymer.

23. The process of claim 15 wherein the PHA is poly(3-hydroxydecanoate) as a homopolymer.

24. The process of claim 15 wherein the PHA is poly(3-hydroxyundecanoate) as a homopolymer.

25. The process of claim 15 wherein the PHA is poly(3-hydroxycodecanoate) as a homopolymer.

26. The process of claim 15 wherein the PHA is poly (3-hydroxybutyrate-co-3-hydroxy valerate) as a copolymer.

27. The process of claim 14 wherein the anhydride bears an unsaturation in its cyclic structure or has a mono unsaturation in its aliphatic side chain.

28. The process of claim 14 wherein the anhydride is maleic anhydride.

29. The process of claim 14 wherein the anhydride is nadic anhydride.

30. The process of claim 14 wherein the anhydride is nadic methyl anhydride.

31. The process of claim 14 wherein the anhydride is octadecenyl succinic anhydride.

32. The process of claim 14 wherein the anhydride is tetradecenyl succinic anhydride.

33. The process of claim 14 wherein the anhydride is hexadecenyl succinic anhydride.

34. The process of claim 14 wherein the anhydride is dodecenyl succinic anhydride.

35. The process of claim 14 wherein the anhydride is tetrapropenyl succinic anhydride.

36. The process of claim 14 wherein the mixing is with a mechanical mixing device which is a single or twin screw extruder.

37. The process of claim 14 wherein the mechanical mixing device is an extruder.

38. The process of claim 14 wherein the mixing is with a roll mill.

39. The process of claim 14 wherein the grafting is carried out in the temperature which is between about 135-190° C.

40. The process of claim 14 wherein a screw speed of a mechanical mixing device is varied between about 50-150 rpm.

41. The process of claim 14 wherein a residence time of the mixing is between about 1 and 5 minutes.

42. The process of claim 14 wherein a free radical initiator is between about 0.4 to 3.0 weight percent (wt %) of the polymer.

43. The process of claim 14 wherein a concentration of anhydride is between 1-15 wt % of the polymer.

44. The process of claim 14 wherein purification of the grafted PHA can be done either in situ or separately.

45. The process of claim 14 wherein an in situ purification of maleated PHA is by applying vacuum to vent off volatile unreacted anhydride.

46. The process of claim 14 wherein an external purification is done by heating the PHA under a dynamic or static vacuum for time ranging between about 6-14 hours.

47. The process of claim 14 wherein the grafting is in a mixing device under an inert atmosphere to control the thermo-oxidative degradation.

48. The process of claim 47 wherein the inert atmosphere is with a non-reactive gas like nitrogen or argon.
